(19) United States
(12) Patent Application Publication
(10) Pub. No.: US 2004/0042478 A1
(43) Pub. Date: Mar. 4, 2004

(54) Method and apparatus for multicast traffic management

(76) Inventor: Drew Bertagna, San Jose, CA (US)

Correspondence Address: Allegro Networks, Inc., 1999 S. Bascom Avenue, Suite 700, Campbell, CA, 95008, US

(21) Appl. No.: 10/233,909

(22) Filed: Sep. 3, 2002

(51) Int. Cl. H04J 3/26

(52) U.S. Cl. 370/432; 370/392

(57) ABSTRACT

A method and apparatus for multicast traffic management in a data communication system allows updates to the multicast subscriber list during the subscriber lookup phase. Duplicate pointers and pointer leakage problems are avoided through temporary use of a theoretical maximum pointer count and eventual replacement of the theoretical maximum pointer count with a true pointer count.

### BACKGROUND OF THE INVENTION

The present invention relates to traffic management in a data communication system, and more particularly to management of multicast traffic in a data communication system.

It is common in data communication systems to use free lists to facilitate traffic flow. In a typical free list arrangement, a pointer to a free buffer in a memory is allocated to a packet from the free list, the packet is written to the buffer using the pointer, the packet is read from the buffer using the pointer when it is the packet's turn for service and the pointer is returned to the free list after the packet is read from the buffer.

Use of free lists in data communication systems which require multicast support gives rise to certain complexities. A multicast packet is typically written into a buffer once, but is read out N times, where N is a subscriber count for the packet. The multiple reads are typically facilitated through subscriber lookup and pointer replication. That is, subscribers for the multicast packet are looked up in a subscriber list and a copy of the pointer allocated to the packet is written to an output queue associated with the subscriber. A copy of the packet is then transmitted to an output interface as the pointer copies are serviced. In performing these operations, care must be taken to ensure that the pointer allocated to a multicast packet is not returned to the free list before a copy of the packet has been read out to all output interfaces, which might result in the eventual return of duplicate pointers to the free list, and is not withheld from the free list after a copy of the packet has been read out to all output interfaces, which might result in pointer leakage.

Critical to avoiding duplicate pointers and pointer leakage is synchronization between the number of pointer copies in the output queues and the pointer count that controls when the pointer is returned to the free list. Synchronization has typically been enforced by initializing the pointer count and performing the subscriber lookup operation using the same version of the subscriber list. Use of the same version of the subscriber list is typically ensured by inhibiting updates to the subscriber list during pointer count initialization and the subscriber lookup phase. Unfortunately, postponing updates to the subscriber list results in the use of stale subscriber information and therefore suboptimal performance of the data communication system. Problems arising from delaying updates may become particularly acute in data communication applications where subscriber lists, and therefore the subscriber lookup phase, is lengthy.

### SUMMARY OF THE INVENTION

In a basic feature, the present invention improves the freshness of subscriber information applied in multicast traffic management in a data communication system by allowing updates to subscriber lists during the subscriber lookup phase. This basic feature is achieved in a preferred embodiment without introducing duplicate pointers and pointer leakage through temporary use of a theoretical maximum pointer count and eventual replacement of the theoretical maximum pointer count with a final true pointer count.

In one aspect, therefore, a method for multicast traffic management comprises receiving a data unit; identifying subscribers for the data unit from a subscriber list whose composition changes in the period between identification of the subscribers; and transmitting the data unit in accordance with the identified subscribers. Composition changes comprise, for example, subscriber additions and deletions.

In another aspect, a system for multicast traffic management comprises a subscriber list having first information for a first subscriber and second information for a second subscriber; and a replicator having access to the list, wherein the replicator accesses from the list the first and second information and applies the first and second information to facilitate transmission of a data unit, and wherein the second information is added to the list after the replicator applies the first information. Facilitating transmission of the data unit comprises, for example, storing a pointer in a first and second output queue associated with the first and second information, respectively.

In yet another aspect, a system for multicast traffic management comprises a subscriber list having first information for a first subscriber and second information for a second subscriber; and a replicator having access to the list, wherein the replicator accesses from the list the first information and applies the first information to facilitate transmission of a data unit, and wherein the second information is deleted from the list after the replicator applies the first information.

These and other aspects of the invention may be better understood by reference to the following detailed description, taken in conjunction with the accompanying drawings which are briefly described below. Of course, the actual scope of the invention is defined by the appended claims.

### BRIEF DESCRIPTION OF THE DRAWINGS

FIG. 1 is a block diagram of a data communication system;

FIG. 2 is a flow diagram illustrating a pointer management protocol for multicast traffic for use within the data communication system of FIG. 1; and

FIG. 3 is a flow diagram illustrating a data management protocol for multicast traffic for use within the data communication system of FIG. 1.

### DETAILED DESCRIPTION OF THE PREFERRED EMBODIMENT

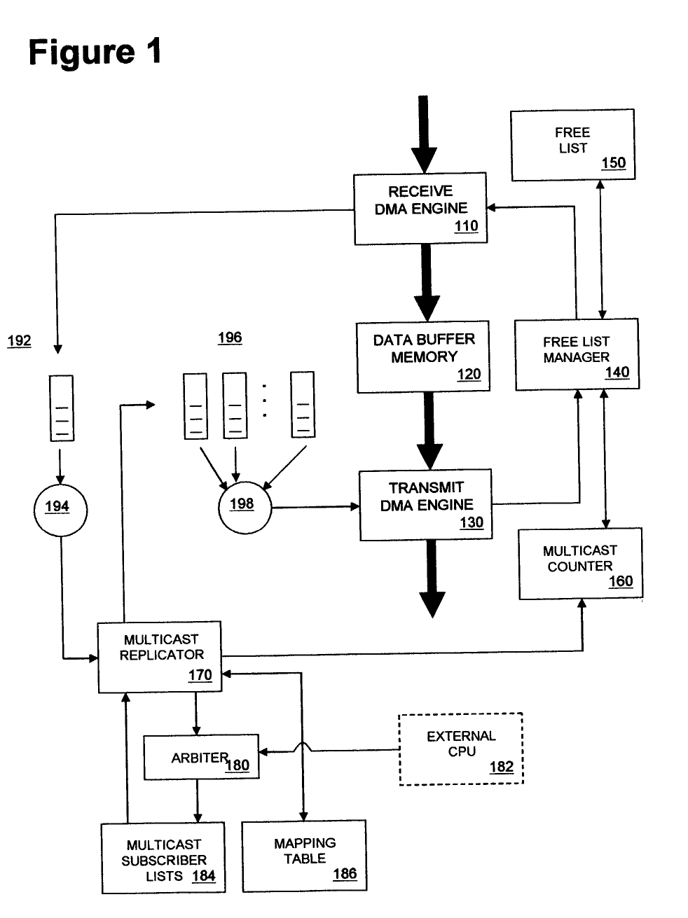

In FIG. 1, a data communication system in which the present invention is operative is shown. The system is preferably implemented in hard-wired logic. An inbound data unit, such as a packet, is received at receive direct memory access (DMA) engine 110 and is transmitted from transmit DMA engine 130 on one or more output interfaces. The packet is stored temporarily in data buffer memory 120, preferably a random access memory (RAM), pending resolution of subscribers and the packet's turn for service. In a preferred embodiment, a subscriber is a logical interface affiliated with an output interface, although in other embodiments of the invention a subscriber may be any type of logical or physical networking entity. Free list manager 140 allocates address space in data buffer memory 120 to the inbound packet by retrieving a pointer to a free buffer from free list 150 and transmitting the pointer to receive DMA engine 110.

Receive DMA engine 110 identifies an inbound packet requiring multicasting (i.e. inbound multicast packet) from packet header information and transmits the pointer allocated for an inbound multicast packet, along with a multicast group identifier identified from packet header information, to multicast queue 192. The inbound multicast packet is written into the free buffer in data buffer memory 120 addressed by the allocated pointer. The pointer is scheduled for service by multicast queue scheduler 194 and when serviced is transmitted to multicast replicator 170.

Upon receiving the pointer, multicast replicator 170 uses the multicast group identifier and initiates a series of requests through arbiter 180 to index into one of multicast subscriber lists 184 and look-up subscribers. Each multicast subscriber list is preferably a singly-linked list associated with a multicast group identifier, with each entry in the list identifying a logical output interface associated with the multicast group identifier. In the subscriber lookup operation, multicast replicator 170, pursuant to a series of grants from arbiter 180 in response to a series of requests, traverses the list associated with the multicast group identifier. On each access instance, multicast replicator 170 retrieves a logical output interface from a looked-up entry and uses the logical output interface to index into mapping table 186 and retrieve an output queue identifier associated with the logical output interface. Multicast replicator 170 then writes a copy of the pointer received from multicast queue 192 to the identified one of output queues 196. The subscriber lookup phase continues until a bit in a looked-up entry in the list indicates that a pointer to the next entry in the list is invalid.

The pointer copies written to output queues 196 are scheduled for service by output queue scheduler 198 and when serviced are transmitted to transmit DMA engine 130, which uses the pointer copies to read copies of the packet out of data buffer memory 120 and transmit the copies of the packet to output interfaces associated with the output queues from which the pointer copies were serviced. Transmit DMA engine 130 additionally passes each pointer copy to free list manager 140, which accesses multicast counter 160 and decrements by one the pointer count for the pointer. If the pointer count is zero after any decrement, free buffer manager 140 returns the pointer to free list 150. Otherwise, free buffer manager 140 inhibits return of the pointer to free list 150.

An important object of the invention is enabling multicast subscriber lists 184 to be updated during the subscriber lookup phase without introducing duplicate pointers or pointer leakage. This object is accomplished by allowing subscriber list updates to proceed while inhibiting return of the pointer to free list 150 until after ultimate, or eventual, synchronization between the number of pointer copies in output queues 196 and the pointer count retained on multicast counter 160 is achieved. Particularly, throughout the subscriber lookup phase, multicast replicator 170 and external central processing unit (CPU) 182 arbitrate for access to multicast subscriber lists 184 through arbiter 180. External CPU 182 requests access to multicast subscriber lists 184 to make additions and deletions thereto as updates become available. To safeguard against premature pointer return in this adaptive list environment, the pointer count for each pointer in free list 150 is initialized on multicast counter 160 to a theoretical maximum number of entries in a multicast subscriber list, that is, a theoretical maximum pointer count (PCₘₐₓ). As pointer copies written in output queues 196 pursuant to traversal of a subscriber list by multicast replicator 170 are serviced and returned to free list manager 140, the pointer count retained for the pointer on multicast counter 160 is decremented from the theoretical maximum. Additionally, as multicast replicator 170 traverses the subscriber list, multicast replicator 170 keeps a count of the number of entries traversed, that is, a true pointer count (PCₜᵣᵤₑ). Then, when multicast replicator 170 finishes traversing the subscriber list, thereby obtaining a final true pointer count (PCₜᵣᵤₑ) which accounts for additions and deletions made to the list made by external CPU 182 during traversal of the list by multicast replicator 170, multicast replicator 170 replaces the decremented theoretical maximum pointer count (PC_{old}) retained for the pointer on multicast counter 160 with a decremented true pointer count (PC_{new}) by substituting in the true pointer count (PCₜᵣᵤₑ) for the theoretical maximum pointer count (PCₘₐₓ), as follows:

PC_{new}=PC_{old}−PCₘₐₓ+PCₜᵣᵤₑ

where

PC_{new}=decremented true pointer count

PC_{old}=decremented theoretical maximum pointer count

PCₘₐₓ=theoretical maximum pointer count

PCₜᵣᵤₑ=true pointer count

It will be appreciated that the decremented true pointer count (PC_{new}) always corresponds to the remaining number of pointer copies in output queues 196, thereby achieving ultimate synchronization. As pointer copies written in output queues 196 continue to be serviced and returned to free list manager 140, the pointer count retained for the pointer on multicast counter 160 is decremented from the decremented true pointer count until the pointer count reaches zero. At that point, free buffer manager 140 returns the pointer to free list 150. It bears noting that any additions or deletions made by external CPU 182 to a portion of a list already traversed by multicast replicator 170 will not be included in the true pointer count (PCₜᵣᵤₑ), but neither will such additions or deletions affect the number of pointer copies in output queues 196.

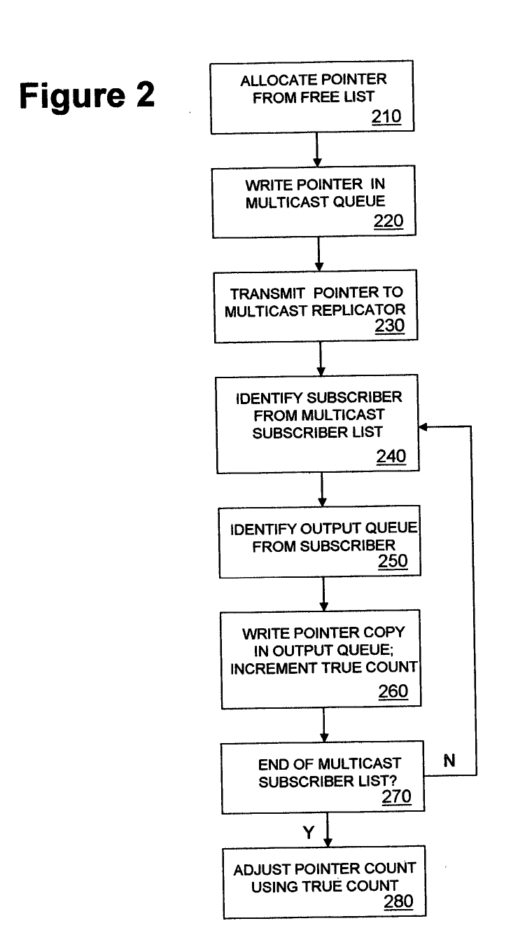

Turning now to FIG. 2, a flow diagram illustrates a pointer management protocol for multicast traffic in accordance with the invention. A pointer to a free buffer is allocated from free list 150 (210), and is written in multicast queue 192 (220). When serviced, the pointer is transmitted to multicast replicator 170 (230). Multicast replicator 170 identifies a subscriber for the pointer from a multicast subscriber list (240). Multicast replicator 170 identifies an output queue from the subscriber (250). Then, multicast replicator 170 writes a copy of the pointer into the identified output queue and increments a true pointer count (260). If multicast replicator 170 has reached the end of the multicast subscriber list (270), multicast replicator 170 updates the pointer count retained for the pointer on multicast counter 160 using the final true pointer count (280). If multicast replicator 170 has not reached the end of the multicast subscriber list (270), the flow returns to Step 240 and additional subscribers are identified. Moreover, as the diagrammed flow progresses, the multicast subscriber list is updated by external CPU 182 as updates become available, with the result that copying of the pointer to output queues 196 associated with subscribers added during traversal of the list by multicast replicator 170 may occur while copying of the pointer to output queues 196 associated with subscribers deleted during the course of traversal of the list by multicast replicator 170 may be inhibited.

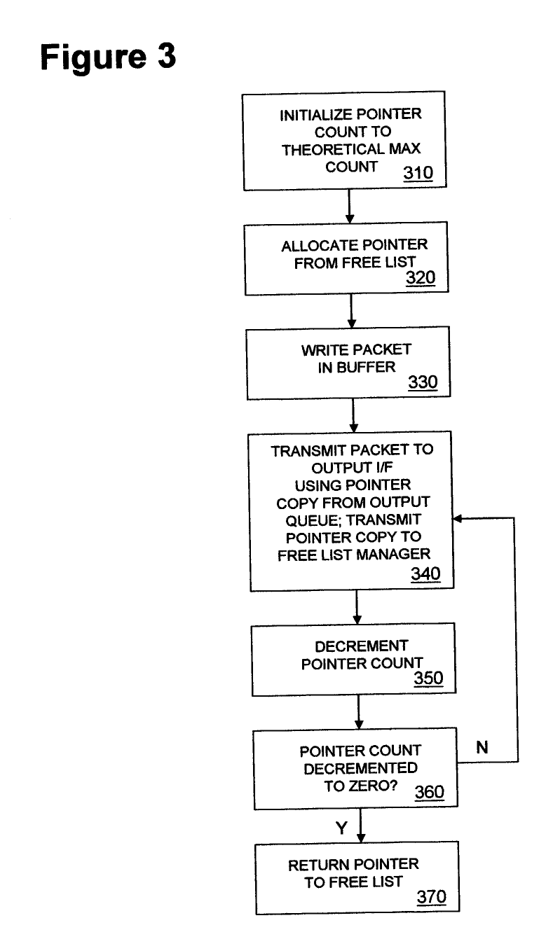

Turning finally to FIG. 3, a flow diagram illustrates a data management protocol for multicast traffic in accordance with the invention. The pointer count for all pointers in free list 150 is initialized to a theoretical maximum pointer count (PCₘₐₓ) in accordance with a theoretical maximum number of entries for a multicast subscriber list (310), thereby safeguarding against premature pointer returns. A pointer to a free buffer is allocated (320), and the packet is written in the buffer (330). The packet is copied to an output interface associated with an output queue from which a pointer copy was serviced and the pointer copy is transmitted to free list manager 140 (340). Free list manager 140 decrements the pointer count (350) and determines whether the pointer count has reached zero (360). If so, the pointer is returned to free list 150 (370). If not, the flow returns to Step 340 and additional copying of packets to output interfaces proceeds. Moreover, at some point in the progression of the diagrammed flow, multicast replicator 170 may have completed traversal of the multicast subscriber list and “swapped in” the true pointer count for the theoretical maximum pointer count to achieve ultimate synchronization.

It will be appreciated by those of ordinary skill in the art that the invention may be embodied in other specific forms without departing from the spirit or essential character hereof. The present description is therefore considered in all respects to be illustrative and not restrictive. The scope of the invention is indicated by the appended claims, and all changes that come within the meaning and range of equivalents thereof are intended to be embraced therein.

I claim:

1. A method for multicast traffic management, comprising:
receiving a data unit;
identifying subscribers for the data unit from a multicast subscriber list whose composition changes in the period between identification of the subscribers; and
transmitting the data unit in accordance with the identified subscribers.

2. The method of claim 1, wherein the composition change includes addition of subscribers.

3. The method of claim 1, wherein the composition change includes deletion of subscribers.

4. The method of claim 1, wherein the subscribers are logical interfaces.

5. The method of claim 1, wherein the subscribers are associated with output interfaces.

6. The method of claim 1, wherein the list comprises entries identifying logical interfaces.

7. The method of claim 1, wherein the list comprises entries associated with output interfaces.

8. The method of claim 1, wherein the transmitting step comprises transmitting the data unit to output interfaces associated with the identified subscribers.

9. A system for multicast traffic management, comprising:
a multicast subscriber list having first information for a first subscriber and second information for a second subscriber; and
a replicator having access to the list,
wherein the replicator accesses from the list the first and second information and applies the first and second information to facilitate transmission of a data unit, and wherein the second information is added to the list after the replicator applies the first information to facilitate transmission of the data unit.

10. The system of claim 9, wherein facilitating transmission of the data unit comprises storing a pointer in a first and second output queue associated with the first and second subscriber, respectively.

11. The system of claim 9, wherein the first and second subscriber are a first and second logical interface, respectively.

12. The system of claim 9, wherein the first and second subscriber are associated with a first and second output interface, respectively.

13. A system for multicast traffic management, comprising:
a multicast subscriber list having first information for a first subscriber and second information for a second subscriber; and
a replicator having access to the list,
wherein the replicator accesses from the list the first information and applies the first information to facilitate transmission of a data unit, and wherein the second information is deleted from the list after the replicator applies the first information.

14. The system of claim 13, wherein facilitating transmission of the data unit comprises storing a pointer in a first output queue associated with the first subscriber.

15. The system of claim 13, wherein the first and second subscriber are a first and second logical interface, respectively.

16. The system of claim 13, wherein the first and second subscriber are associated with a first and second output interface, respectively.

17. A method for multicast traffic management, comprising:
generating a multicast subscriber list having first information for a first subscriber;
applying the first information to facilitate transmission of a data unit to a first output interface;
after applying the first information, adding to the list second information for a second subscriber; and
applying the second information to facilitate transmission of the data unit to a second output interface.

18. The method of claim 17, wherein facilitating transmission of the data unit to the first and second output interface comprises storing a pointer in a first and second output queue associated with the first and the second output interface, respectively.

19. A method for multicast data traffic management, comprising:
generating a multicast subscriber list having first information for a first subscriber and second information for a second subscriber;
applying the first information to facilitate transmission of a data unit; and
inhibiting application of the second information to facilitate transmission of the data unit.

20. The method of claim 19, wherein the inhibiting step comprises deleting from the list the second information.
